(19) United States
(12) Patent Application Publication
(10) Pub. No.: US 2018/0137097 A1
(43) Pub. Date: May 17, 2018

(54) ELECTRONIC DEVICE AND CONTROL METHOD THEREFOR

(71) Applicant: Samsung Electronics Co., Ltd., Suwon-si, Gyeonggi-do (KR)

(72) Inventors: Su-min LIM, Yongin-si (KR); O-hoon KWON, Suwon-si (KR); Mu-woong LEE, Seongnam-si (KR)

(21) Appl. No.: 15/572,383

(22) PCT Filed: Jun. 1, 2016
(86) PCT No.: PCT/KR2016/005788

§ 371 Date: Nov. 7, 2017

(30) Foreign Application Priority Data
Jun. 16, 2015 (KR) 10-2015-0085018

(51) Int. Cl. G06F 17/27; G06F 17/24; G06F 3/0482; H04L 12/58

(52) U.S. Cl. CPC G06F 17/277; G06F 17/24; H04L 51/10; H04L 51/20; H04L 51/04; G06F 3/0482

(57) ABSTRACT

An electronic device and a control method thereof are provided, the method including receiving a message including text, analyzing the text included in the message, determining a type of the message and acquiring context information related to the type of the message, and determining a recommended image for responding to the message based on the context information and providing the recommended image.

### TECHNICAL FIELD

The present disclosure relates to an electronic device and a control method thereof, more particularly, to an electronic apparatus which automatically provides a recommended image in response to a message received from outside, and a control method thereof.

### BACKGROUND ART

Recently, mobile devices such as not only a smart phone but also a smart watch and a smart glass, etc. have increased. Also, with the development of Internet of Things (IoT) technology, a variety of devices can be connected with one another freely, and accordingly, the need for the provision of the functions for user convenience using a mobile device has increased.

However, such mobile devices (e.g., wearable devices) do not often include the component for physically inputting text, or it is often difficult to input text in the devices. It is also inconvenient to connect such devices with the device on which a user can input text easily, such as a smart phone, to use the devices. Further, even in the case of a smart phone on which text can be input easily, there could be the situation where it is difficult to input text (for example, when a user is driving).

Thus, the need for transmitting a response message more instantly and conveniently in response to a received message has been emerged.

### DETAILED DESCRIPTION FOR THE INVENTION

### Problem to Solve

An aspect of example embodiments relates to an electronic device which, when a message is received, analyzes the type of the message and context information, and provides a recommended image as a responding message, and a control method thereof.

### Means to Solve the Problem

According to an example embodiment, a control method of an electronic device is provided, the method including receiving a message including text; analyzing the text included in the message, determining a type of the message, and acquiring context information related to the type of the message; and determining a recommended image for responding to the message based on the context information and providing the recommended image.

The method may further include, if a message regarding a position inquiry is received before the message is received, when position information is input as a response to the message regarding a position inquiry, displaying a guide UI for inquiring whether the position information is registered; and registering the position information when a registration command for the position information is input through the guide UI.

The acquiring may include, if a type of the message is a message regarding a position inquiry, acquiring the registered position information as context information, and the providing may include determining a recommended image for responding to the message based on the registered position information and providing the recommended image.

The acquiring may include, if a type of the message is a message regarding a position inquiry, acquiring position information acquired based on at least one of position information detected by a GPS, schedule information and wireless network connection information as context information.

The acquiring may include, if a type of the message is an inquiry message regarding a current activity of a user who uses the electronic device, acquiring activity information acquired based on at least one of currently executed application information and pre-stored schedule information as the context information.

The acquiring may include, if a type of the message is an inquiry message regarding a current activity of a user who uses the electronic device, acquiring motion information of the electronic device which is sensed by at least one of sensors as the context information.

The acquiring may include, if a type of the message is an inquiry message regarding a current activity of a user who uses the electronic device, when an external device connected with the electronic device is present, acquiring information of the external device which is received from the connected external device as the context information.

The providing may include, if there are a plurality of recommended images which are determined based on the context image, displaying a list of recommended images including the plurality of recommended images.

The method may further include, if it is detected that the electronic device is in a position that is not pre-registered for a predetermined period of time, automatically transmitting current position information as a response to the message.

According to an example embodiment, an electronic device is provided, the electronic device including a communicator configured to receive a message including text; a controller configured to analyze the text included in the message, to determine a type of the message, to acquire context information related to the type of the message, and to determine a recommended image for responding to the message based on the context information; and a display configured to provide the determined recommended image.

If a message regarding a position inquiry is received before the message is received, when position information is input as a response to the message regarding a position inquiry, the controller may control the display to display a guide UI for inquiring whether the position information is registered, and register the position information when a registration command for the position information is input through the guide UI.

If a type of the message is a message regarding a position inquiry, the controller may acquire the registered position information as context information and determine a recommended image for responding to the message based on the registered position information.

If a type of the message is a message regarding a position inquiry, the controller may acquire position information acquired based on at least one of position information detected by a GPS, schedule information and wireless network connection information as context information.

If a type of the message is an inquiry message regarding a current activity of a user who uses the electronic device, the controller may acquire activity information acquired based on at least one of currently executed application information and pre-stored schedule information as the context information.

If a type of the message is an inquiry message regarding a current activity of a user who uses the electronic device, the controller may acquire motion information of the electronic device which is sensed by at least one of sensors as the context information.

If a type of the message is an inquiry message regarding a current activity of a user who uses the electronic device, when an external device connected with the electronic device is present, the controller may acquire information of the external device which is received from the connected external device as the context information.

If there are a plurality of recommended images which are determined based on the context image, the controller may control the display to display a list of recommended images including the plurality of recommended images.

If it is detected that the electronic device is in a position that is not pre-registered for a predetermined period of time, the controller may control the communicator to automatically transmit current position information as a response to the message.

### Effect of Invention

According to the various example embodiments, a user may respond to a message more easily and conveniently through a recommended image.

### THE BRIEF DESCRIPTION OF THE DRAWINGS

FIG. 1 is a block diagram illustrating a configuration of an electronic device briefly according to an example embodiment;

FIG. 2 is a block diagram illustrating a configuration of an electronic device in detail according to an example embodiment;

FIGS. 3A to 11 are diagrams illustrating various example embodiments in which a generated recommended image is provided according to context information according to an example embodiment; and

FIG. 12 is a flowchart illustrating a control method of an electronic device according to an example embodiment.

### DETAILED DESCRIPTION OF EXAMPLE EMBODIMENTS

Before describing example embodiments specifically, the terms used in the example embodiments will be described briefly.

With respect to the terms used in an example embodiment of the disclosure, general terms currently and widely used are selected in view of function with respect to the disclosure. However, the terms may vary according to an intention of a technician practicing in the pertinent art, an advent of new technology, etc. In specific cases, terms may be chosen arbitrarily, and in this case, definitions thereof will be described in the description of the corresponding disclosure. Accordingly, the terms used in the description should not necessarily be construed as simple names of the terms, but be defined based on meanings of the terms and overall contents of the present disclosure.

The terms including ordinal number such as “first,” “second,” and so on may be used in the description and the claims to distinguish the elements from one another. These terms are used only for the purpose of differentiating one component from another, without limitation thereto. For example, the first element may be named the second element without departing from the scope of right of the various example embodiments of the present disclosure, and similarly, the second element may be named the first element. The term “and/or” includes a combination of a plurality of described relevant items or any item of a plurality of described relevant items.

A singular term includes a plural form unless otherwise indicated.

The terms, “include,” “comprise,” “is configured to,” etc. of the description are used to indicate the presence of features, numbers, steps, operations, elements, parts or combination thereof, and do not exclude the possibilities of combination or addition of one or more features, numbers, steps, operations, elements, parts or combination thereof.

In an example embodiment, ‘a module’ or ‘a unit’ performs at least one function or operation, and may be realized as hardware, software, or combination thereof. Further, except the “modules” or “units” that have to be implemented by certain hardware, a plurality of “modules” or a plurality of “units” may be integrated into at least one module and realized as at least one processor (not illustrated).

In the example embodiments, in the case where a certain part is “connected” to the other part, it may include not only the case where the part is “directly connected” to the other part, but also the case where the part is “electrically connected” to the other part with another element interposed therebetween.

Also, in the example embodiments, a user input may include at least one of a touch input, a bending input, a voice input, a button input, and a multimodal input, but is not limited thereto.

In the example embodiments, the term “application” may refer to a set of computer programs designed to perform a specific function. There could be a variety of application in the example embodiments. For example, an application may be a game application, a video reproduction application, a map application, a memo application, a calendar application, a phone book application, a broadcasting application, an exercise support application, a payment application, a photo folder application, or the like, but is not limited thereto.

In the example embodiments, the “context information” may refer to the information which indicates the surrounding situation of an electronic device or the situation of a user who is using an electronic device, and the context information may be acquired using GPS information, wireless communication connection information, schedule information, application usage information, information on a connected external device, or the like.

All the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having ideal or exaggerated meanings unless they are clearly defined in the various example embodiments.

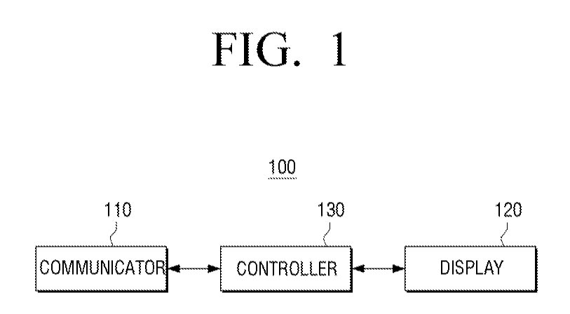

Hereinafter, the present disclosure will be described in detail with reference to the accompanying drawings. FIG. 1 is a diagram illustrating a configuration of an electronic device according to an example embodiment. As illustrated in FIG. 1, the electronic device 100 may include a communicator 110, a display 120, and a controller 130. The electronic device 100 according to an example embodiment may be implemented as various electronic devices such as a smart phone, a smart watch, a smart glass, a tablet PC, a laptop, or the like.

The communicator 110 may communicate with an external device. The communicator 110 may transmit to and receive from an external device a message which includes text or an image.

The display 120 may output image data. The display 120 may display a message window which includes a message that is transmitted to and is received from an external device, and may include a recommended image in the message window.

The controller 130 may control overall operations of the electronic device 100. The controller 130 may analyze text included in a message received through the communicator 110, determine the type of the message, acquire context information related to the type of the message, and determine a recommended image for responding to the message based on the context information. Also, the controller 130 may control the display 120 to provide the determined recommended image.

Specifically, the controller 130 may control the communicator 110 to receive a message including text from an external device.

The controller 130 may analyze the text included in the received message and determine the type of the message. For example, the controller 130 may perform a natural language processing to the received message and perform a lexical analysis, and determine the type of the message based on whether a certain text is present based on the analysis result. For instance, as the result of analysis, if the word “where” is included in the message, the controller 130 may determine the type of the message as a message regarding a position inquiry. As another example, as the result of analysis, if the words “what” and “doing” are included in the message, the controller 130 may determine the type of the message as a message inquiring an activity of a user.

The controller 130 may acquire context information based on the determined type of message. Particularly, if it is determined that the type of the message is a message regarding a position inquiry, the controller 130 may acquire position information as context information. For example, if a message regarding a position inquiry is received before the message is received, when position information is input as a response to the message regarding a position inquiry, the controller 130 may control the display 120 to display a guide UI for inquiring whether the position information is registered. When a registration command for the position information through the guide UI, the controller 130 may register the position information as context information. As another example, the controller 130 may acquire the position information acquired based on at least one of position information detected by a GPS, schedule information and wireless network connection information as context information.

If the type of the message is an inquiry message regarding a current activity of a user who uses the electronic device 100, the controller 130 may acquire activity information acquired based on at least one of executed application information and pre-stored schedule information as context information. The controller 130 may also acquire motion information of the electronic device 100 which is sensed by at least one of sensors as context information. The controller 130 may also acquire the information of a connected external device which is received from the external device as context information.

The controller 130 may determine a recommended image based on the acquired context information. For example, if the type of the message is a message regarding a position inquiry, and it is determined that the current position is a user's house based on the position information that is the context information, the controller 130 may determine a recommended image (e.g., a recommended emoticon) corresponding to the house. The controller 130 may control the display 110 to provide the determined recommended image. If there are a plurality of recommended images which are determined based on the context information, the controller 130 may control the display 120 to display a list of recommended images including the plurality of recommended images.

If it is detected that the electronic device 100 is in the position that is not pre-registered for a certain period of time, the controller 130 may control the communicator 110 to automatically transmit the current position information as a response to the message. In other words, if it is determined that a user is in the dangerous area, the controller 130 may automatically transmit the information of the current position of the user to a counterpart, and inform the counterpart of the dangerous situation.

As described above, a user may transmit a response message suitable for a current situation by a minimum user input using the electronic device 100.

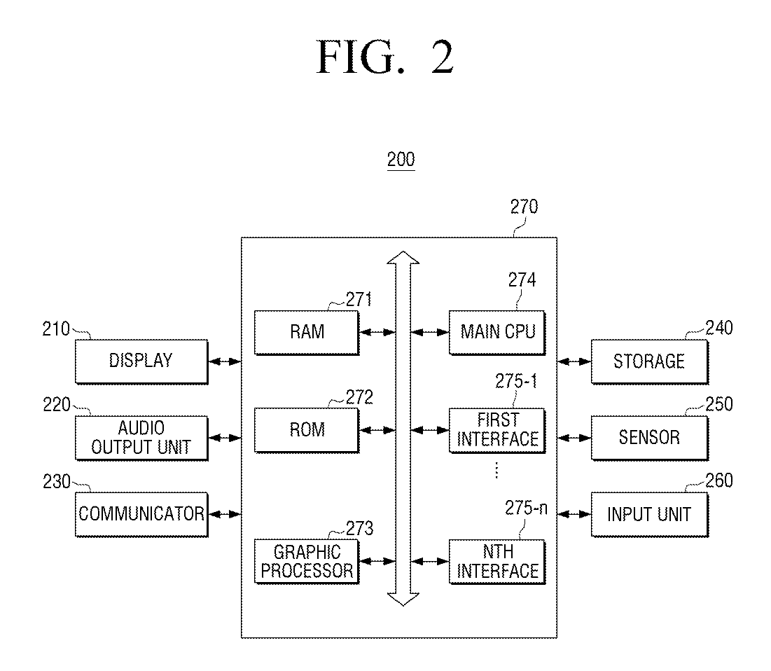

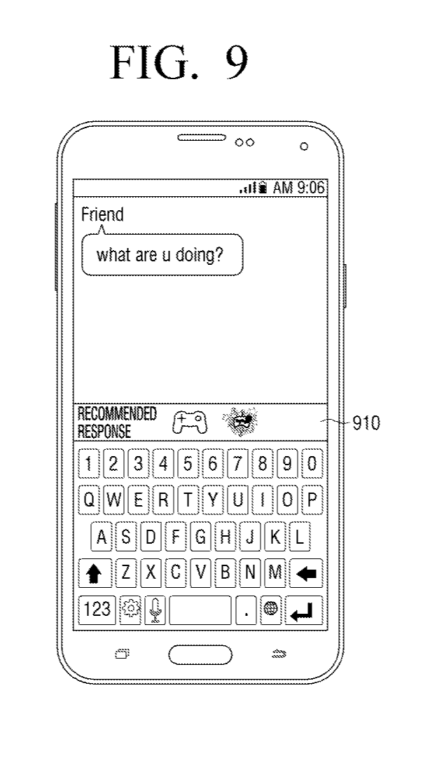

Hereinafter, various example embodiments will be described with reference to FIGS. 2 to 11. FIG. 2 is a block diagram illustrating a configuration of the electronic device 200 in detail according to an example embodiment. As illustrated in FIG. 2, the electronic device 200 may include a display 210, an audio output unit 220, a communicator 230, a storage 240, a sensor 250, an input unit 260 and a controller 270.

FIG. 2 illustrates the elements by using the example of the device which has various functions such as a text input function, a message transmitting and receiving function, a display function, or the like. Depending on an example embodiment, some of the elements illustrated in FIG. 2 may be omitted or changed, or other elements may be added.

The display 210 may display image data received from an image receiver (not illustrated), a video frame processed in an image processor (not illustrated), and at least one of various screens generated in a graphic processor 273. The display 210 may also display a message window including the message which is transmitted to and received from an external device. The display 210 may include at least one of a recommended image and a keyboard UI in the message window and display the message window.

The audio output unit 220 may be configured to output not only various audio data to which a variety of processing operations, such as decoding, amplifying, or a noise filtering, are performed by an audio processor (not illustrated) but also various alarm sounds or a voice message. The audio output unit 220 may be implemented as a speaker, but is not limited thereto. The audio output unit 220 may also be implemented as an output terminal which can output audio data.

The communicator 230 may be configured to communicate with various types of external devices according to diverse types of communication methods. The communicator 230 may include various communication chips such as a Wi-Fi chip, a Bluetooth chip, an NFC chip, a wireless communication chip, or the like. The Wi-Fi chip, the Bluetooth chip and the NFC chip may communicate by a Wi-Fi method, a Bluetooth method, and an NFC method, respectively. The NFC chip may refer to the chip which operates by a near field communication (NFC) method which uses a frequency band of 13.56 MHz from among various RF-ID frequency bands such as 135 kHz, 13.56 MHz, 433 MHz, 860˜960 MHz, 2.45 GHz, or the like. When using the Wi-Fi chip or Bluetooth-chip, the communicator 230 may transmit and receive various connection information such as an SSID, a session key, etc., perform communication connection using the information, and transmit and receive various information. The wireless communication chip may refer to the chip which communicates according to various communication protocols, such as IEEE, ZigBee, 3rd Generation (3G), 3rd Generation Partnership (3GP), Long Term Evolution (LTE), or the like.

The communicator 230 may transmit a message to and receive a message from an external device. The communicator 230 may also receive the information of an external device (e.g., the information on currently displayed content) from an external device by a nearfield communication with the external device.

The storage 240 may store various modules for operating the electronic device 200. For example, in the storage 240, the software which includes a base module, a sensing module, a communication module, a presentation module, a web browser module, and a service module may be stored. The base module may be a basic module which processes the signals transmitted from each hardware included in the electronic device 200 and transmits the signals to an upper layer module. The sensing module may be the module which collects information from various sensors, and analyzes and manages the connected information, and may include a face recognition module, a voice recognition module, a motion recognition module, an NFC recognition module, or the like. The presentation module may be the module for configuring a display screen, and may include a multimedia module for reproducing and outputting multimedia content, and a UI rendering module for performing a UI processing and a graphic processing. The communication module may be the module for communicating with an external entity. The web browser module may be the module for performing a web browsing and accessing a web server. The service module may be the module which includes various applications for providing a variety of services.

As described above, the storage 240 may include various program modules, and the program modules may be omitted, changed, or added depending on the type and the characteristics of the electronic device 200. For example, if the electronic device 200 is implemented as a tablet PC, the base module may further include a position determination module for a position determination based on a GPS, and the sensing module may further include a sensing module which senses a motion of a user.

The storage 240 may include a natural language processing module for a lexical analysis of text included in a received message. The storage 240 may also include a context information acquisition module for acquiring various context information. The storage 240 may also store a recommended image (e.g., an emotion, etc.).

According to an example embodiment, the storage 240 may include a ROM 272 and a RAM 271 provided in the controller 270 or a memory card (not illustrated; for example, a micro SD card, a memory stick) provided in the electronic device 200.

The sensor 250 may detect the surrounding environment of the electronic device 200. The sensor 250 may include various sensors such as a GPS sensor which can detect position information, a motion sensor (e.g., a gyro sensor, an acceleration sensor, etc.) which can sense the motion of the electronic device 200, a pressure sensor, a noise sensor, or the like.

The input unit 260 may receive a user command for controlling the electronic device 200. The input unit 260 may include a touch input unit, a button, a voice input unit, a motion input unit, a keyboard, a mouse, or the like, to receive a user command.

The controller 270 may control overall operations of the electronic device 200 using various programs stored in the storage 240.

As illustrated in FIG. 2, the controller 270 may include a RAM 271, a ROM 272, a graphic processor 273, a main CPU 274, a first to nth interfaces 275-1 to 275-n, and a buss 276. The RAM 271, the ROM 272, the graphic processor 273, the main CPU 274, and the first to nth interfaces 275-1 to 275-n may be connected to one another through the buss 276.

In the ROM 272, a command word set, etc. for booting a system may be stored. Once a turn-on command is input and power is supplied, the main CPU 274 may copy the O/S stored in the storage 240 to the RAM 271 according to the command word stored in the ROM 272, and boot a system by executing the O/S. Once the booting is completed, the main CPU 274 may copy various application programs stored in the storage 240 to the RAM 271, execute the application program copied to the RAM 271 and operate various operations.

The graphic processor 273 may generate the screen including various objects such as a pointer, an icon, an image, text, etc. using a computation unit (not illustrated) and a rendering unit (not illustrated). The computation unit may calculate an attribute value such as a coordinate value, a form, a size, a color, etc. with which each object is displayed according to the layout of the screen using a control command received from an input unit. The rendering unit may generate screens with various layouts which include an object based on the attribute values calculated in the computation unit. The screen generated in the rendering unit may be displayed in the display area on the display 210.

The main CPU 274 may access the storage 240, and perform booting using the O/S stored in the storage 240. The main CPU 274 may perform various operations using various programs, content, data, etc. which are stored in the storage 240.

The first to nth interfaces 275-1 to 275-n may be connected with the elements described above. One of the interfaces may be a network interface which is connected with an external device via a network.

The controller 270 may analyze the text included in the message which is received from an external device through the communicator 230 and determine the type of the received message. The controller 270 may acquire context information related to the type of the message, and determine a recommended image for responding to the message based on the context information. The controller 270 may control the display 210 to provide the determined recommended image.

The controller 270 may receive a message from an external device through the communicator 230. The message may be directly received from the external device, but is not limited thereto. The message may be also received via a mediating device such as a server or a base station. The message received from an external device may include one of text, an image file and an audio file.

The controller 270 may analyze the text included in the message received from the external device and determine the type of the message.

For example, the controller 270 may perform a lexical analysis to the text included in a message through an NLP module. The controller 270 may perform a morpheme analysis, a syntactic analysis, and a speech act analysis to the text included in the message, and determine whether the text included in the message includes a certain word on the basis of the result of the analysis. For example, the controller 270 may determine whether an interrogative (e.g., “where,” “when,” “what,” etc.), a certain noun (e.g., “you,” “U,” etc.), and a certain verb (e.g., “are,” “go,” “do,” etc.) are included in the text included in the message through a lexical analysis. If a certain word which is stored in the storage 240 is included, the controller 270 may analyze the certain word and determine the type of the received message. For example, the words “where,” “U,” and “are” are included in the text included in the received message, the controller 270 may determine that the type of message is a message regarding a position inquiry. As another example, the words “where,” “U,” “are,” and “doing” are included in the text included in the received message, the controller 270 may determine that the type of the message is a message inquiring a current activity of a user who uses the electronic device 200.

The controller 270 may acquire context information based on the determined type of message. According to an example embodiment, if the type of message is a message regarding a position inquiry, the controller 270 may acquire position information as context information. The position information may be acquired in various ways.

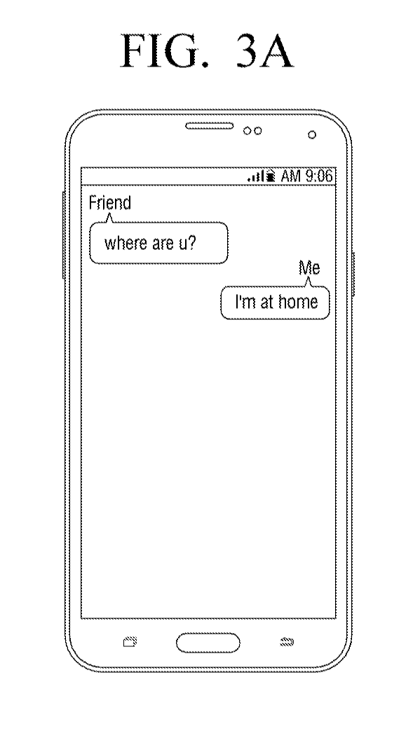

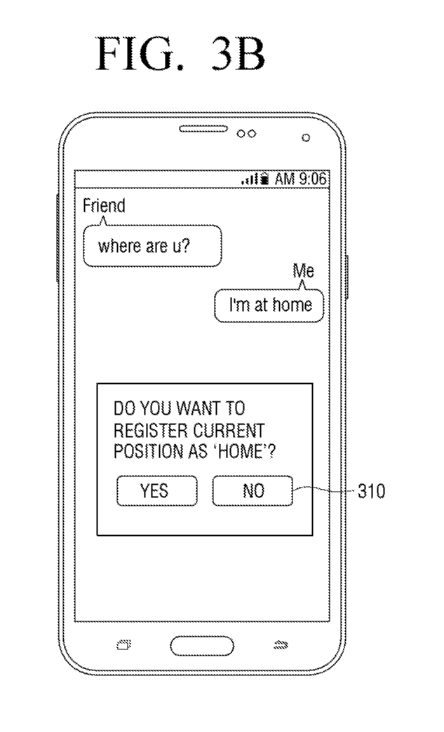

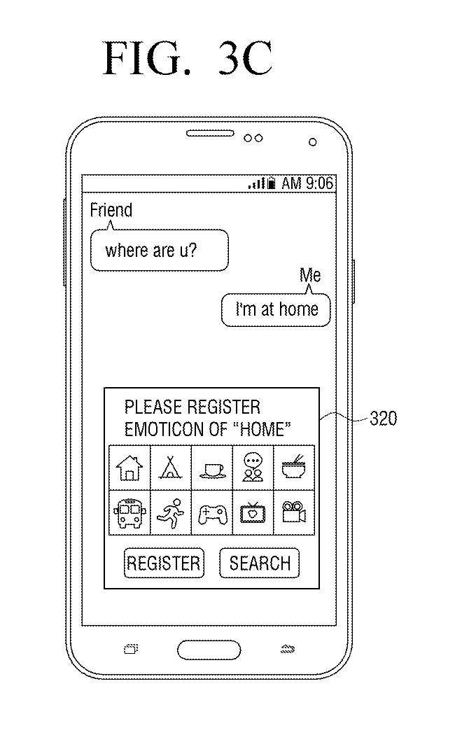

First, the controller 270 may acquire the position information which is registered as a current position as context information before a message is received. The method for registering a current position will be described with reference to FIGS. 3A, 3B and 3C.

For example, as illustrated in FIG. 3A, when the message “Where are U” is received, and if the responding message “I'm at home” is input as a response to the received message, the controller 270 may perform a lexical analysis and determine that the word “home” that is related to a position is included in the responding message. If it is determined so, the controller 270 may control the display 210 to display a guide UI 310 which inquires whether to register the current position as illustrated in FIG. 3B. If the command for registering the current position is input through the guide UI 310, the controller 270 may register the information of the current position as the position information. The controller 270 may also register a recommended image (e.g., an emoticon, a photograph, a picture, etc.) related to the position information with the position information. For example, the controller 270 may also store a pre-stored recommended image related to the position information, and as illustrated in FIG. 3C, the controller 270 may store the recommended image through a registration UI for registering a recommended emoticon with the position information. In other words, the controller 270 may match a recommended emoticon with the registered position information and store the recommended emoticon.

As another example, the controller 270 may acquire the position information that is acquired based on at least one of position information detected by a GPS, schedule information and wireless network connection information as context information. For example, when the information on the latitude and the longitude of the current position detected by a GPS sensor is received, the controller 270 may acquire the current position information based on the received latitude and longitude. As another example, if the schedule “exercising in the park from 3:00 PM to 4:00 PM” is stored in the storage 240, the controller 270 may determine the position information between 3:00 PM and 4:00 PM as a ‘park.’ As third example, if the ID of the currently connected AP is “XX department store,” the controller 270 may determine the current position information as “XX department store.”

The controller 270 may determine a recommended image based on the determined position information. For example, as described above, the controller 270 may determine the emoticon that is matched to the pre-stored position information as a recommended image. As another example, the controller 270 may search for an image related to the determined position information and determine the retrieved image as a recommended image. For example, if the current position is a coffee shop of a certain brand, the controller 270 may search for the image (e.g., the coffee shop brand image) related to the determined current position through the Internet and determine the retrieved image as a recommended image.

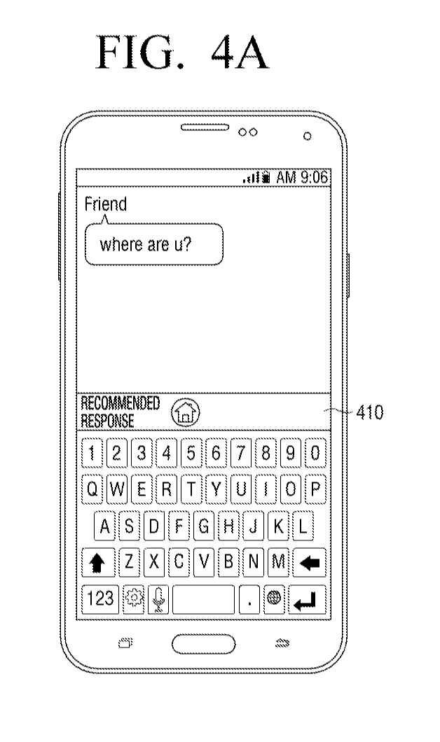

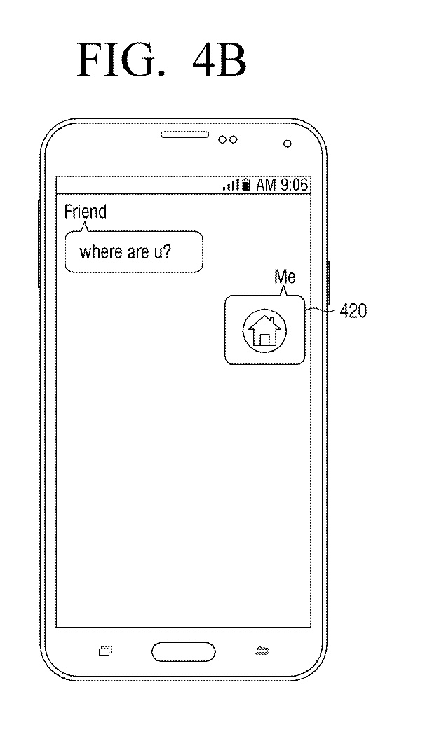

The controller 270 may provide the determined recommended image to a user. For example, if the message including the text “Where are U” is received from an external device, the controller 270 may determine a recommended image based on the determined position information by the same method above, and as illustrated in FIG. 4A, the controller 270 may control the display 210 to provide a recommended image on an area 410 in the message window. When a user command for selecting a recommended image is input through an input unit 260, the controller 270 may control the communicator 230 to transmit the selected recommended image to an external device, and as illustrated in FIG. 4B, the controller 270 may control the display 210 to display the recommended image 420 as a responding message on the message window.

The above example embodiment describes that the controller 270 may determine a recommended image based on context information, but is not limited thereto. The controller 270 may also determine a recommended phrase based on context information and provide the recommended phrase. The recommended phrase may be acquired by the same method as the method for acquiring a recommended image. Thus, the recommended image may be pre-registered to be matched to context information by a user, or may be searched for from outside.

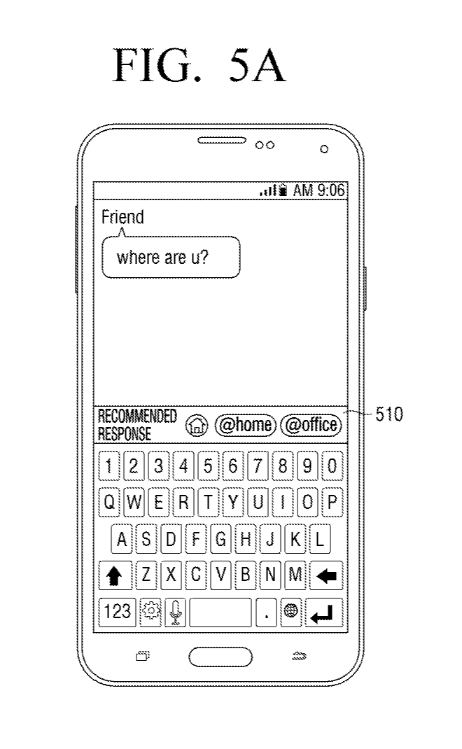

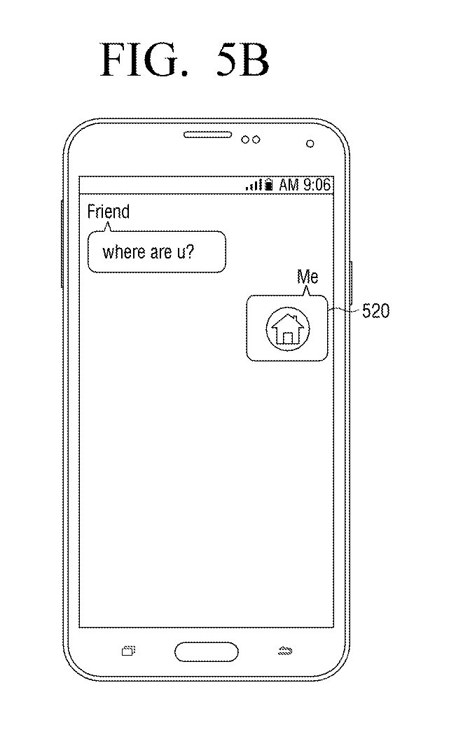

If both the recommended image and the recommended phrase are present simultaneously in response to the determined context information, the controller 270 may control the display 210 to display a recommended list including both the recommended image and the recommended phrase on an area 510 in the message window as illustrated in FIG. 5A. If the recommended image is selected between the recommended image and the recommended phrase which are displayed on the area 510 in the message window, the controller 270 may control the communicator 230 to transmit the selected recommended image to an external device, and as illustrated in FIG. 5B, the controller 270 may control the display 210 to display the recommended image 520 as a responding message on the message window.

As another example embodiment, if the type of message is a message regarding a current activity of a user who uses the electronic device 200, the controller 270 may acquire the activity information which is acquired based on at least one of the currently executed application information and the pre-stored schedule information as context information.

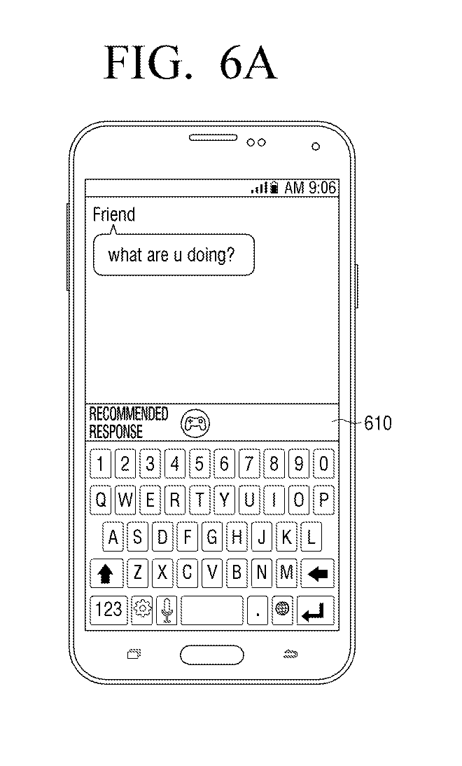

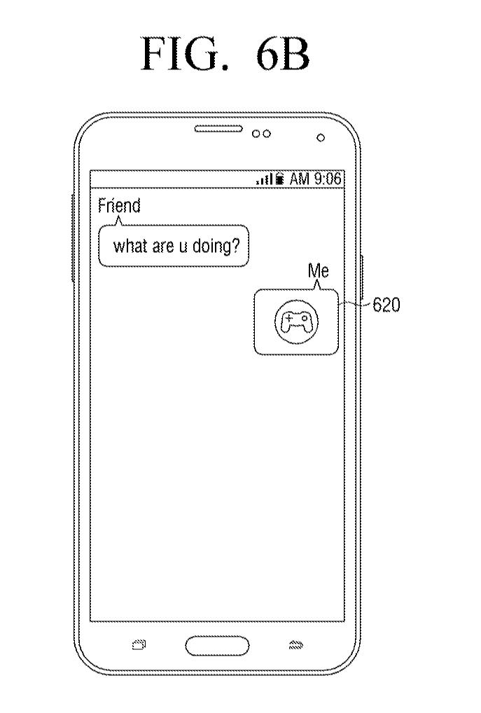

For example, as illustrated in FIG. 6A, if the message received from the outside is “What are U doing,” the controller 270 may determine that the type of the received message is an inquiry message regarding a current activity of a user who uses the electronic device 200 by a lexical analysis. The controller 270 may analyze the information of the application currently executed in the electronic device 200 or the pre-stored schedule information to acquire the information on the current activity of the user. For example, if the application that is currently executed in the electronic device 200 is a game application, the controller 270 may determine that the user who uses the electronic device 200 is currently playing a game as context information, and may determine a recommended image related to the game. The recommended image related to the game may be pre-stored, but is not limited thereto. The recommended image may be searched for from the outside. The recommended image related to the game may be a general, game-related image (e.g., a joystick emoticon, etc.), but is not limited thereto. The recommended image may be an image (e.g., the logo of the currently executed game, etc.) related to the currently executed game. As illustrated in FIG. 6A, the controller 270 may control the display 210 to display the recommended image on one are 610 in the message window. If a user command for selecting a recommended image is input through the input unit 260, the controller 270 may control the communicator 230 to transmit the selected recommended image to an external device, and as illustrated in FIG. 6B, the controller 270 may control the display 210 to display the recommended image 620 as a responding message on the message window.

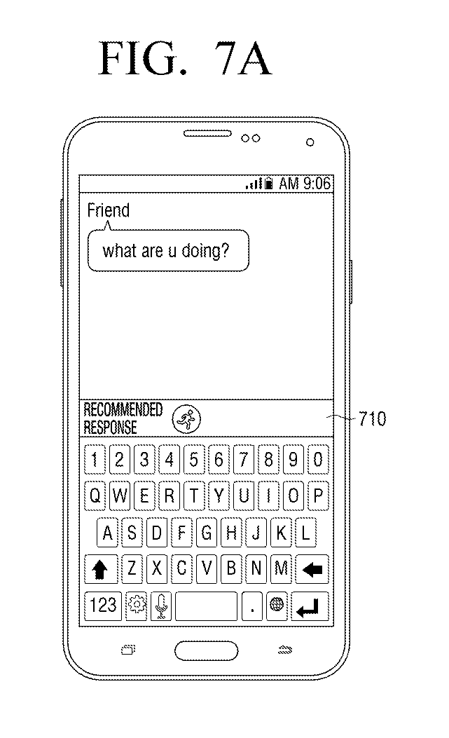

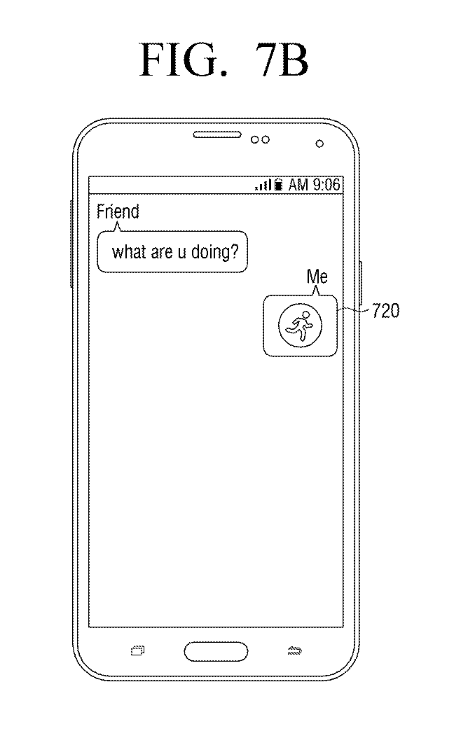

Also, as illustrated in FIG. 7A, if the message received from the outside is “What are U doing,” the controller 270 may determine that the type of the received message is an inquiry message regarding a current activity of a user who uses the electronic device 200 by a lexical analysis. The controller 270 may acquire the information on the motion of the electronic device 200 using at least one of sensors (e.g., a gyro sensor, an acceleration sensor, a tilt sensor, etc.) to acquire the information on a current activity of the user. If the motion of the electronic device 200 which is sensed by at least one of the sensors is consistent with or similar to the motion of a pre-stored motion pattern (e.g., the motion pattern of when a user is exercising), the controller 270 may determine that a user who uses the electronic device 200 is exercising as context information, and may determine a recommended image related to the exercise. The recommended image related to the exercise may be pre-stored, but is not limited thereto. The recommended image may be searched for from the outside. As illustrated in FIG. 7A, the controller 270 may control the display 210 to display the recommended image on one are 710 in the message window. If a user command for selecting a recommended image is input through the input unit 260, the controller 270 may control the communicator 230 to transmit the selected recommended image to an external device, and as illustrated in FIG. 7B, the controller 270 may control the display 210 to display the recommended image 720 as a responding message in the message window. Meanwhile, the above example embodiment describes that the context information may be acquired using the motion information of the electronic device 200, but is not limited thereto. The context information may be acquired using biometric information (e.g., pulse information, etc.) of a user which is acquired by at least one of the sensors.

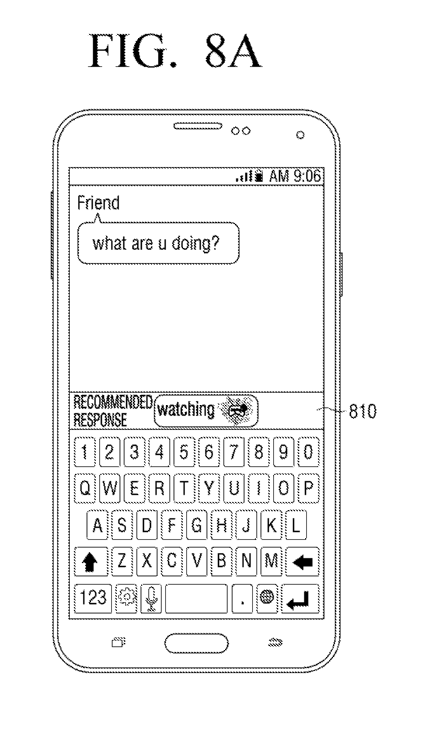

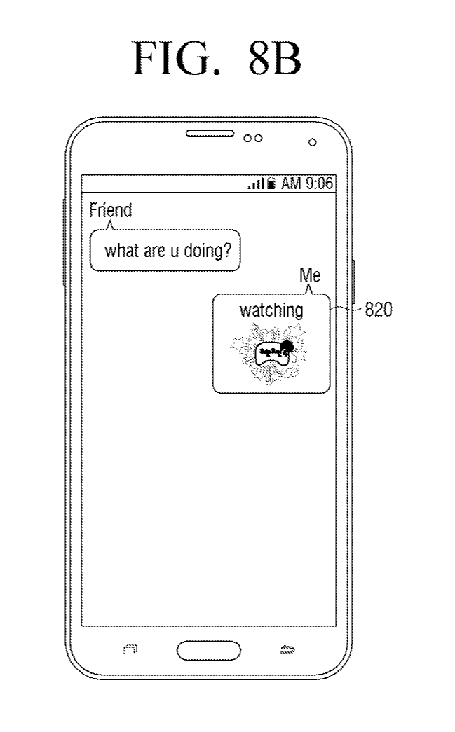

As illustrated in FIG. 8A, if the message received from the outside is “What are U doing,” the controller 270 may determine that the type of the received message is an inquiry message regarding a current activity of a user who uses the electronic device 200 by a lexical analysis. The controller 270 may request the information on an external device from the currently connected external device to acquire the information on a current activity of the user. For example, if the electronic device 200 is a smart phone and the connected external device is a TV, the controller 270 may control the communicator 230 to request the information on the currently displayed video content from the TV. Also, if the electronic device 200 is a smart watch, and the connected external device is a smart phone, the controller 270 may control the communicator 230 to request the information on the application currently executed in the smart phone. The controller 270 may determine the video content which a user is currently viewing based on the received information on the external device (e.g., the metadata related to the currently displayed video content), and may determine that the user is currently viewing the video content as context information. The controller 270 may determine the recommended image related to the program which a user is currently viewing. The recommended image related to the currently viewed program may be pre-stored, but is not limited thereto. The recommended image may be searched for from the outside. As illustrated in FIG. 8A, the controller 270 may control the display 210 to display the recommended image on an area 810 in the message window. The recommended image may include the verb (e.g., watching) which represents the action of a user. If a user command for selecting a recommended image is input through the input unit 260, the controller 270 may control the communicator 230 to transmit the selected recommended image to an external device, and as illustrated in FIG. 8B, the controller 270 may control the display 210 to display the recommended image 820 on the message window as a responding message.

In the above example embodiment, the example of the type of message is a message regarding a position inquiry, a message inquiring a current activity of a user, etc., but is not limited thereto. For example, various types of messages such as a message inquiring the time of appointment, a message inquiring a fellow passenger, etc. may also be included in the technical concept.

The above example embodiment describes that the determined recommended image may be of one individual, but is not limited thereto. A plurality of recommended images may be determined based on various context information. For example, if a currently executed application is a game application, and the information on “video content A” is received from a connected external device, the controller 270 may control the display 210 to display a recommended image list including the image related to the game and the image related to the video program A on an area 910 in the message window as a recommended image.

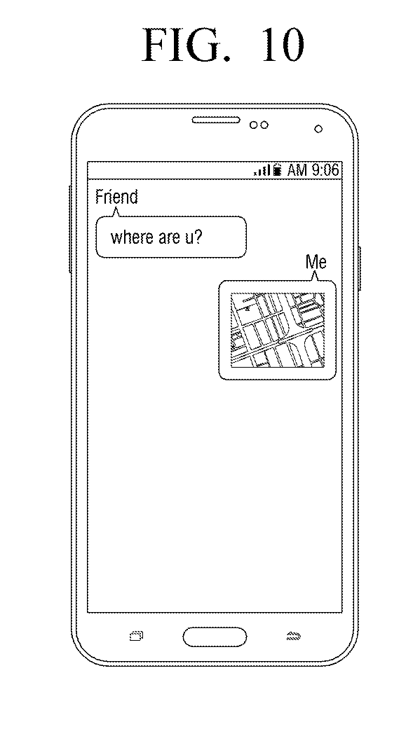

In another example embodiment, the controller 270 may automatically transmit a recommended image in response to a message even without an input of a user command. For example, after a message is received, if it is detected that the electronic device 200 is present in the position (e.g., on the mountain) which is not pre-registered for a predetermined period time (e.g., six hours), the controller 270 may control the communicator 230 to automatically transmit the current position information as a response to the received message. In other words, the controller 270 may control the communicator 230 to automatically transmit a map image which indicates the current position information, and as illustrated in FIG. 10, the controller 270 may control the display 210 to display the map image on the message window. Accordingly, the dangerous situation of a user who uses the electronic device 200 may be guided more actively. However, as the function of guiding a danger may be associated with one's privacy, the function may be configured to be turned on or off by user settings.

As the third example, if the received message is an inquiry message (e.g., “What are U doing”) regarding a current activity of a user, the controller 270 may determine that a user is currently in the situation where the user cannot respond to the message based on various information. For example, if a connected external device is a navigation, or if the velocity of the electronic device 200 is 60˜100 km per hour, the controller 270 may determine that a user is currently driving as context information. The controller 270 may also determine that a user is currently in the shower based on the schedule information. If it is determine that a user is currently in the situation where the user cannot respond to the message, the controller 270 may control the communicator 230 to automatically transmit the recommended image related to the current activity of a user. For example, it is determined that a user is currently driving, the controller 270 may control the communicator 230 to automatically transmit the recommended image related to driving. On the message window, the recommended image related to driving may be displayed.

If a residual battery is currently less than a predetermined value (e.g., 5%), the controller 270 may control the communicator 230 to automatically transmit a responding message “I will contact you later” in response to receiving a message. The controller 270 may control the communicator 230 to automatically transmit a responding message on the basis of the level of intimacy (the frequency of sending and receiving a message) to prevent responding to an unnecessary counterpart (e.g., a spam).

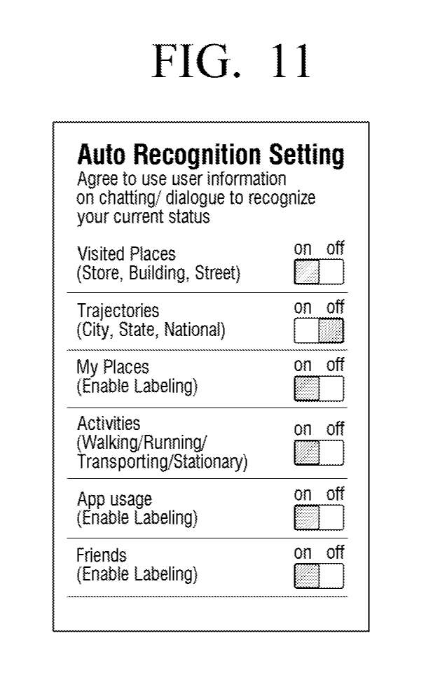

There may the possibility of infringement on a user's privacy when context information is acquired. Accordingly, as illustrated in FIG. 11, a setting UI for setting the context information which the electronic device 200 is allowed to collect may be provided. For example, if a user does not want a position tracking, the user may turn off the function of acquiring the context information related to a position tracking which is included in the setting UI.

The above example embodiment describes that a lexical analysis is performed to the text included in the message of a counterpart and that a recommended image is provided, but is not limited thereto. The recommended message may be provided using the text included in the message input by a user. For example, if the message that a user inputs is “I'm at,” the controller 270 may determine that the word which comes after the preposition is associated with a position. Accordingly, the controller 270 may acquire the context information related to a current position, and control the display 210 to provide a recommended image related to the current position based on the context information.

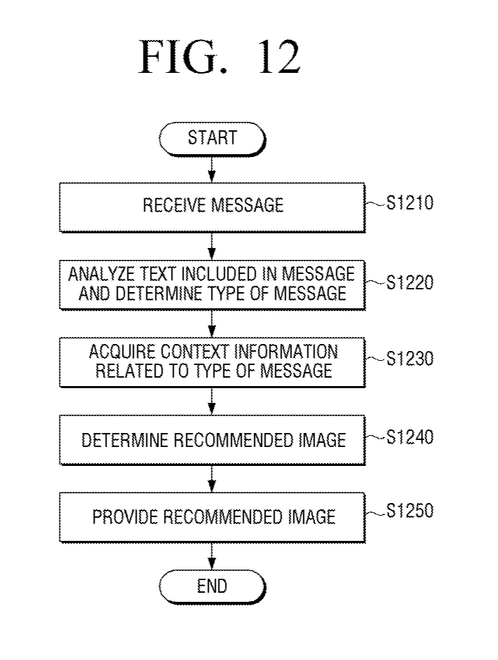

Hereinafter, a control method of an electronic device 100 will be described with reference to FIG. 12 according to an example embodiment.

The electronic device 100 may receive a message from an external device (S1210).

The electronic device 100 may analyze the text included in the message and determine the type of the message (S1220). For example, the electronic device 100 may perform a lexical analysis to the text included in the message through an NLP module, and determine the type of message based on whether a certain word is included in the text.

The electronic device 100 may acquire context information related to the type of message (S1230). For example, if the message is regarding a position inquiry, the electronic device 100 may acquire position information as context information, and if the message is an inquiry message regarding an activity of a user, the electronic device 100 may acquire the information on the current activity of the user as context information.

The electronic device 100 may determine a recommended image based on the context information (S1240). The recommended image may be pre-stored, or may be searched for from the outside (e.g., the Internet).

The electronic device 100 may provide the recommended image (S1250). For example, the controller 100 may provide the recommended image on one area in the message window. If the recommended image is selected according to a user command, the electronic device 100 may transmit the recommended image to an external device, and display the recommended image on the message window as a responding message.

By the various example embodiments described above, a user may transmit a responding message including a recommended image suitable for a current situation more conveniently with a minimum input.

Meanwhile, the aforementioned method may be implemented in a general use digital computer configured to operate a program using a non-transitory computer readable record medium that is capable of writing a program executable in the computer and of reading the program using the computer. Furthermore, a structure of data used in the aforementioned method may be recorded in the non-transitory computer readable record medium through various means. Examples of the non-transitory computer readable record medium include storage media such as a magnetic storage medium (for example, ROM, floppy disk, hard disk and the like), optic readable medium (for example, compact disc [CD] ROM, digital versatile disc [DVD] and the like).

The foregoing example embodiments are merely examples and are not to be construed as limiting the present disclosure. The description of the example embodiments is intended to be illustrative, and not to limit the scope of the disclosure, as defined by the appended claims, and many alternatives, modifications, and variations will be apparent to those skilled in the art.

What is claimed is:

1. A control method of an electronic device comprising:
receiving a message including text;
analyzing the text included in the message, determining a type of the message, and acquiring context information related to the type of the message; and
determining a recommended image for responding to the message based on the context information and providing the recommended image.

2. The method of claim 1, further comprising:
if a message regarding a position inquiry is received before the message is received, when position information is input as a response to the message regarding a position inquiry, displaying a guide UI for inquiring whether the position information is registered; and
registering the position information when a registration command for the position information is input through the guide UI.

3. The method of claim 2, wherein the acquiring comprises, if a type of the message is a message regarding a position inquiry, acquiring the registered position information as context information, and
wherein the providing comprises determining a recommended image for responding to the message based on the registered position information and providing the recommended image.

4. The method of claim 1, wherein the acquiring comprises, if a type of the message is a message regarding a position inquiry, acquiring position information acquired based on at least one of position information detected by a GPS, schedule information and wireless network connection information as context information.

5. The method of claim 1, wherein the acquiring comprises, if a type of the message is an inquiry message regarding a current activity of a user who uses the electronic device, acquiring activity information acquired based on at least one of currently executed application information and pre-stored schedule information as the context information.

6. The method of claim 1, wherein the acquiring comprises, if a type of the message is an inquiry message regarding a current activity of a user who uses the electronic device, acquiring motion information of the electronic device which is sensed by at least one of sensors as the context information.

7. The method of claim 1, wherein the acquiring comprises, if a type of the message is an inquiry message regarding a current activity of a user who uses the electronic device, when an external device connected with the electronic device is present, acquiring information of the external device which is received from the connected external device as the context information.

8. The method of claim 1, wherein the providing comprises, if there are a plurality of recommended images which are determined based on the context image, displaying a list of recommended images including the plurality of recommended images.

9. The method of claim 1, further comprising:
if it is detected that the electronic device is in a position that is not pre-registered for a predetermined period of time, automatically transmitting current position information as a response to the message.

10. An electronic device comprising:
a communicator configured to receive a message including text;
a controller configured to analyze the text included in the message, to determine a type of the message, to acquire context information related to the type of the message, and to determine a recommended image for responding to the message based on the context information; and
a display configured to provide the determined recommended image.

11. The electronic device of claim 10, wherein, if a message regarding a position inquiry is received before the message is received, when position information is input as a response to the message regarding a position inquiry, the controller controls the display to display a guide UI for inquiring whether the position information is registered, and registers the position information when a registration command for the position information is input through the guide UI.

12. The electronic device of claim 11, wherein if a type of the message is a message regarding a position inquiry, the controller acquires the registered position information as context information and determines a recommended image for responding to the message based on the registered position information.

13. The electronic device of claim 10, wherein, if a type of the message is a message regarding a position inquiry, the controller acquires position information acquired based on at least one of position information detected by a GPS, schedule information and wireless network connection information as context information.

14. The electronic device of claim 10, wherein if a type of the message is an inquiry message regarding a current activity of a user who uses the electronic device, the controller acquires activity information acquired based on at least one of currently executed application information and pre-stored schedule information as the context information.

15. The electronic device of claim 10, wherein if a type of the message is an inquiry message regarding a current activity of a user who uses the electronic device, the controller acquires motion information of the electronic device which is sensed by at least one of sensors as the context information.
